(19) United States
(12) Patent Application Publication
(10) Pub. No.: US 2025/0232348 A1
(43) Pub. Date: Jul. 17, 2025

(54) Methods, Systems, and Electronic Devices for Monitoring User Interaction Events in Electronic Shopping Interactive Computing Environs

(71) Applicant: Motorola Mobility LLC, Chicago, IL (US)

(72) Inventors: Krishnan Raghavan, Bangalore (IN); Vignesh Karthik Mohan, Bangalore (IN); Nakul Patel, Nagpur (IN)

(21) Appl. No.: 18/411,630

(22) Filed: Jan. 12, 2024

(51) Int. Cl. G06Q 30/0601

(52) U.S. Cl. CPC G06Q 30/0625; G06Q 30/0635

(57) ABSTRACT

An electronic device includes a user interface, a memory, and one or more processors. In response to the one or more processors detecting commencement of an interactive session in an electronic shopping application operating on the processors, the one or more processors initiate a timer for each search string category detected. In response to the interactive session ceasing, the one or more processors present a compilation of timer data for the interactive session. The compilation can itemize each search string category and a corresponding amount of time associated with each search string category.

### BACKGROUND

### Technical Field

This disclosure relates generally to electronic devices, and more particularly to electronic devices having user interfaces.

### Background Art

Portable electronic devices, such as smartphones and tablet computers, are now the primary electronic tools with which people communicate, engage in commerce, maintain calendars and itineraries, monitor health, capture images and video, and surf the Internet. In many instances, a person is more likely to carry a smartphone than a watch or wallet. Indeed, with the advent of personal finance, banking, and shopping applications many people can transact personal business solely using a smartphone and without the need for cash or a physical credit card. When used in conjunction with e-commerce sites, such devices make it incredibly simple to purchase goods and services with just a click or two.

While such technology is incredibly convenient, the ease with which modern electronic devices can engage in electronic commerce transactions can cause unintended issues for a user. It would be advantageous to have improved devices and systems to address such unintended issues.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1A illustrates one or more method steps in accordance with one or more embodiments of the disclosure.

FIG. 1B illustrates one or more method steps in accordance with one or more embodiments of the disclosure.

FIG. 1C illustrates one or more method steps in accordance with one or more embodiments of the disclosure.

FIG. 2 illustrates one explanatory electronic device in accordance with one or more embodiments of the disclosure.

FIG. 3 illustrates one explanatory method in accordance with one or more embodiments of the disclosure.

FIG. 4 illustrates one explanatory user interface in accordance with one or more embodiments of the disclosure.

FIG. 5 illustrates another explanatory user interface in accordance with one or more embodiments of the disclosure.

FIG. 6 illustrates still another explanatory user interface in accordance with one or more embodiments of the disclosure.

FIG. 7 illustrates various embodiments of the disclosure.

FIG. 8 illustrates a prior art method.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to, in response to initiation of an interactive session in an electronic shopping interactive computing environment operating on one or more processors of an electronic device, detecting, by a user interface operable with the one or more processors, user input defining a search string having a category associated therewith, initiating a timer, monitoring user interaction events in the electronic shopping interactive computing environment until the search string or category changes, and then pausing the timer. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of, in response to one or more processors of an electronic device detecting commencement of an interactive shopping session in an electronic shopping application operating on the one or more processors, initiating a timer for each search string and/or category detected and, in response to the interactive shopping session ceasing, presenting a compilation of timer data for the interactive shopping session itemizing each search string and/or category and a corresponding amount of time associated with each search string category as described herein. The non-processor circuits may include, but are not limited to, a radio receiver, a radio transmitter, signal drivers, clock circuits, power source circuits, and user input devices.

As such, these functions may be interpreted as steps of a method to initiating a timer for each detected category of activity occurring during an interactive session of an electronic shopping interactive computing environment operating on one or more processors of an electronic device, detecting completion of an interactive shopping cart event within the electronic shopping interactive computing environment for at least one detected category of activity, stopping the timer in response to completion of the interactive shopping cart event within the electronic shopping interactive computing environment, and presenting, by the one or more processors on a user interface of the electronic device, a compilation of the data from the timer for each detected category of activity occurring during the interactive session. Alternatively, some or all functions could be implemented by a state machine that has no stored program instructions, or in one or more application specific integrated circuits (ASICs), in which each function or some combinations of certain of the functions are implemented as custom logic.

Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent. The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

New electronic shopping interactive computing environments are popping up everywhere. Illustrating by example, “Hello Shopping” is a new online marketplace service offered by Motorola Mobility intended to empower its customers to be able to purchase anything they desire, from fashion to appliances, and home décor to books, with those items being curated by reliable brands and partners at great prices. This service is now being rolled out in Brazil but is expected to incrementally launch in other regions as well. Consumer adoption of these electronic shopping interactive computing environments is growing at a phenomenal pace. This is especially true after the Sars-Cov-2 pandemic.

Embodiments of the disclosure contemplate that users spend considerable amounts of time using electronic shopping interactive computing environments. Indeed, session lengths of shopping interactions in electronic shopping interactive computing environments have increased nearly twenty percent in the last two years.

Embodiments of the disclosure also contemplate that users frequently spend far more time than actually required to complete a shopping experience in an electronic shopping interactive computing environment due to distractions and other “attractions” offered by the electronic shopping interactive computing environment. While this is useful for purveyors of the electronic shopping interactive computing environment, in that they are able to show shoppers more wares, it can sometimes not be the best use of time for the shopper.

To wit, gullible users sometimes are lured deep into the depths of the electronic shopping interactive computing environment by recommendations and specials, sometimes forgetting their personal schedules and even losing rack of time. It would not be unfair to say that this problem exists in the real world as well. However, in the real-world people have physical escape routes. Illustrating by example, they may simply get tired, or a physical store may have a fixed closing time before which all transactions must be completed.

Electronic shopping interactive computing environments have no such guardrails. People can shop for hours on end with no limitations. While this ability to shop all day can be convenient for consumers, it can also backfire for businesses. This is especially true when the shopper does not complete an originally intended purchase due to overwhelming distractions or choices.

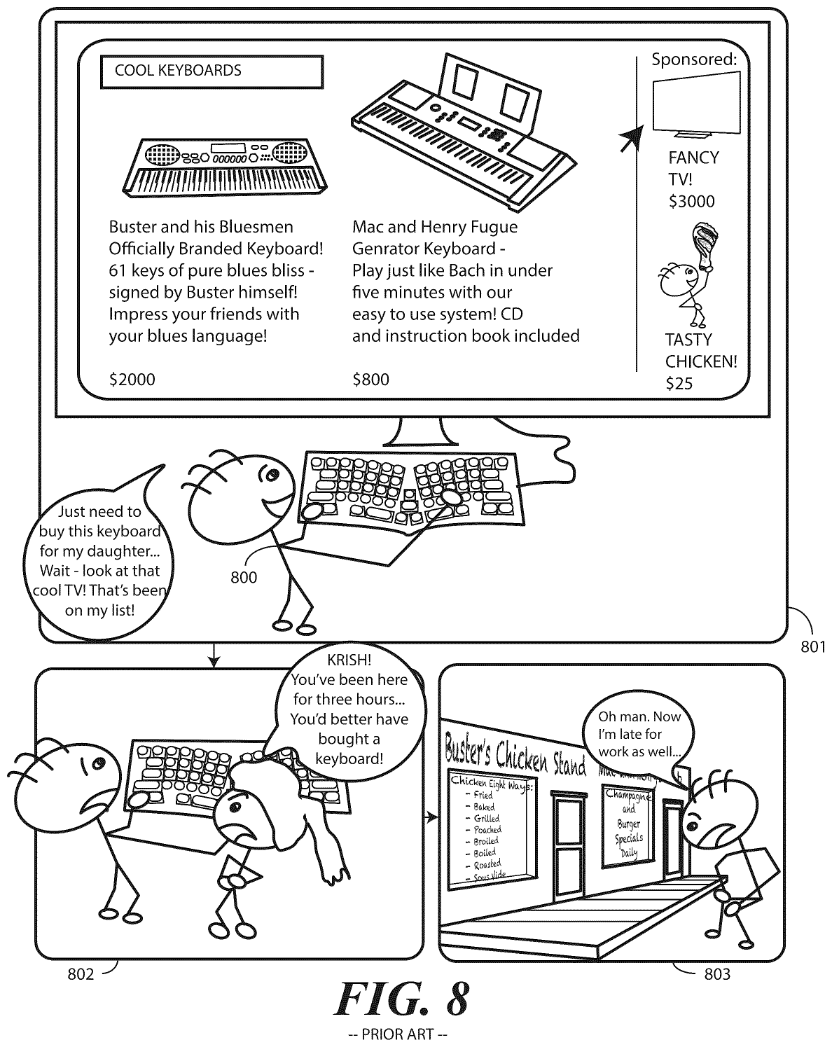

To illustrate by example, turn now to FIG. 8. At step 801, our shopper 800, Krish, has a busy day at work and is preparing for a meeting in the next fifteen minutes. At the same time, he is reminded of a promise he made to his daughter to order a musical keyboard. Thus, he commences an interactive session in an electronic shopping interactive computing environment to find just the right keyboard.

Unfortunately, the purveyor of the electronic shopping interactive computing environment shopping portal has been studying the cookies stored on Krish's device. This purveyor knows that Krish is also looking to buy a really super fancy television for himself. Accordingly, in sponsored ads presented alongside the search results Krish has pulled up for “cool keyboards,” the purveyor offers advertisements for a fancy television at the discounted price of three thousand dollars and for tasty chicken from Buster's Chicken Stand, where delicious chicken is served eight ways daily. These ways include fried, baked, grilled, poached, broiled, boiled, roasted, and sous vide. Despite having pulled up really great results for his daughter, namely the Buster and his Bluesmen Officially Branded Keyboard for the blues and the Mac and Henry Fugue Generator that allows even a novice to play like Bach, Krish can't help but be drawn to that really super fancy television.

Despite thinking he can purchase a keyboard in only a few minutes, he instantly becomes distracted and clicks on a link for the really super fancy television. He starts researching the television and comparing it to others. Before he knows it, he spends over two whole hours investigating television sets. At step 802, his wife comes in and begins to scold Krish and scold him well. She tells him that he's been there for three hours and better have purchased a keyboard, as he's not only late for work but has completely missed his meeting. Of course, he has purchased no keyboard and instead has wasted the better part of the day. At step 803, downtrodden and feeling low, he heads to work many hours late.

Poor Krish. However, he is not alone. Consider Vignesh, who wants to purchase a smartphone for his parents. When he opens an electronic shopping interactive computing environment, he enters “mobile phones” as a search string, in response to which he is presented several options. As he spends more time on the content presented in the site, he happens to notice a sidebar on the right that shows items left in an interactive shopping cart in response to interactive shopping cart events. He also sees a bottom bar that shows recommendations based upon his past purchase history.

Distracted, Vignesh clicks on each of these to see more sections, including “products purchased together,” “popular brands,” and other flashy groupings. Vignesh clicks on each and ultimately loses track to time. After an hour of browsing, he realizes that he has not spent any time on the mobile phone and has made no purchase. It becomes clear to Vignesh that he has lost focus and has wasted his day.

Advantageously, embodiments of the disclosure provide a solution to these problems. In one or more embodiments, a method in an electronic device tracks the amount of time taken by users to browse through products in an electronic shopping interactive computing environment. In one or more embodiments, the methods display the tracked time to the user on a user interface at various points during the shopping experience in the electronic shopping interactive computing environment.

In one or more embodiments, methods and systems present the time spent on a particular product type. In other embodiments, the methods and systems present the time spent in a singular interactive session within the electronic shopping interactive computing environment across multiple search strings or products viewed. In one or more embodiments, the times spent on various products or search strings can be summed across an interactive session within an electronic shopping interactive computing environment. Once the user finalizes the interactive session, compilation timer data for the interactive session can be presented on a user interface for the user's review. Advantageously, embodiments of the disclosure create a sense of focus and urgency in the minds of a user engaging in an interactive session within an electronic shopping interactive computing environment. In one or more embodiments, the time or timer complication is featured prominently to help users not lose track of the same.

In one or more embodiments, one or more processors of an electronic device start tracking time when a user begins searching for a product or expresses interest in a product within an electronic shopping interactive computing environment. The time taken can be prominently shown, such as in a virtual stopwatch presentation, while the user is engaging in the interactive session. This helps to sensitize this information in the user's mind.

In one or more embodiments, every time the user changes the product type or search string, the timer is paused and a new (separate) timer for the newly searched product type is started. When the user returns to an earlier searched product type or search string, the previous timer can be resumed. This can repeat across sections until an interactive shopping session completes or ceases. In one or more embodiments, when the user clicks on time shown in the electronic shopping interactive computing environment, they are presented with an information panel that shows the amount of time spent on various products during the interactive shopping session. In one or more embodiments, this provides a quick previous of how much time was spent on different types of products. In one or more embodiments, it also provides an indication of which of those products were finalizes with purchases.

In still another embodiment, the system tracks the amount of time for a detected category across multiple sessions. Thereafter, once a purchase is finally made, the system can report the amount of time spent on the detected category across sessions or that purchase. Illustrating by example, imagine Nakul has been trying to purchase a smartphone for more than a week and has spent a large number of hours looking at specifications, comparing phones, and his purchase is still not complete. Now imagine that a week later Nakul finally does complete the smartphone purchase. In one or more embodiments, the system can present a compilation of the time spent not only in the most recent session, but in the prior sessions as well. In one or more embodiments, this information can also be presented in a report at the conclusion of the purchase. Essentially, in this embodiment the tracking and aggregation of time occurs across sessions until a purchase is completed. Thereafter, the timer can be reset.

In one or more embodiments, when a user sees this information, they instantly know how much time was spent (or wasted) on products intentionally searched or on unrelated products. In one or more embodiments, compilation timer data showing the total time spent during the interactive shopping session is also shown in the information panel at the user's request.

In one or more embodiments, the amount of time spent to finalize any purchases is also shown in the order summary of the product, emails, and other summary reports. In one or more embodiments, at the end of an interactive shopping session, the one or more processors of the electronic device can also present the ratio of time taken to add products to the interactive session shopping cart and on times not added to the interactive session shopping cart. In one or more embodiments, these data points emphasis how well the user utilized time in this interactive shopping session and in other summary pages or reports.

In one or more embodiments, a method for an electronic device comprises, in response to initiation of an interactive session in an electronic shopping interactive computing environment operating on one or more processors of the electronic device, detecting, by a user interface operable with the one or more processors, user input defining a search string having a category associated therewith. In one or more embodiments, the method comprises initiating, by the one or more processors in response to the user input, a timer.

In one or more embodiments, the method comprises monitoring, by the one or more processors, user interaction events in the electronic shopping interactive computing environment to determine whether the category associated with the search string changes. In one or more embodiments, when the category associated with the search string fails to change, the method continues the timer until the interactive session ceases, and thereafter stops the timer. However, when the category associated with the search string changes to another category associated with another search string, the method pauses the timer and initiates another timer. In one or more embodiments, the method presents, by the one or more processors on the user interface, a compilation of timer data for the interactive session after the interactive session ceases.

In one or more embodiments, an electronic device comprises a user interface, a memory, and one or more processors operable with the user interface and the memory. In one or more embodiments, in response to the one or more processors detecting commencement of an interactive shopping session in an electronic shopping application operating on the one or more processors, the one or more processors initiate a timer for each search string category detected.

In one or more embodiments, in response to the interactive shopping session ceasing, the one or more processors present a compilation of timer data for the interactive shopping session itemizing each search string category and a corresponding amount of time associated with each search string category. In one or more embodiments, the one or more processors present the timer data in a virtual stopwatch on the user interface.

In one or more embodiments, a method in an electronic device comprises initiating, by one or more processors of the electronic device, a timer for each detected category of activity occurring during an interactive session of an electronic shopping interactive computing environment operating on the one or more processors of the electronic device. In one or more embodiments, the method comprises detecting, by the one or more processors, completion of an interactive shopping cart event within the electronic shopping interactive computing environment for at least one detected category of activity. In one or more embodiments, the method comprises detecting, by the one or more processors, completion of a purchase event within the electronic shopping interactive computing environment for at least one detected category of activity. In one or more embodiments, the method comprises stopping, by the one or more processors, the timer in response to completion of the interactive shopping cart event within the electronic shopping interactive computing environment. In one or more embodiments, the method comprises presenting, by the one or more processors on a user interface of the electronic device, a compilation of timer data from the timer for each detected category of activity occurring during the interactive session.

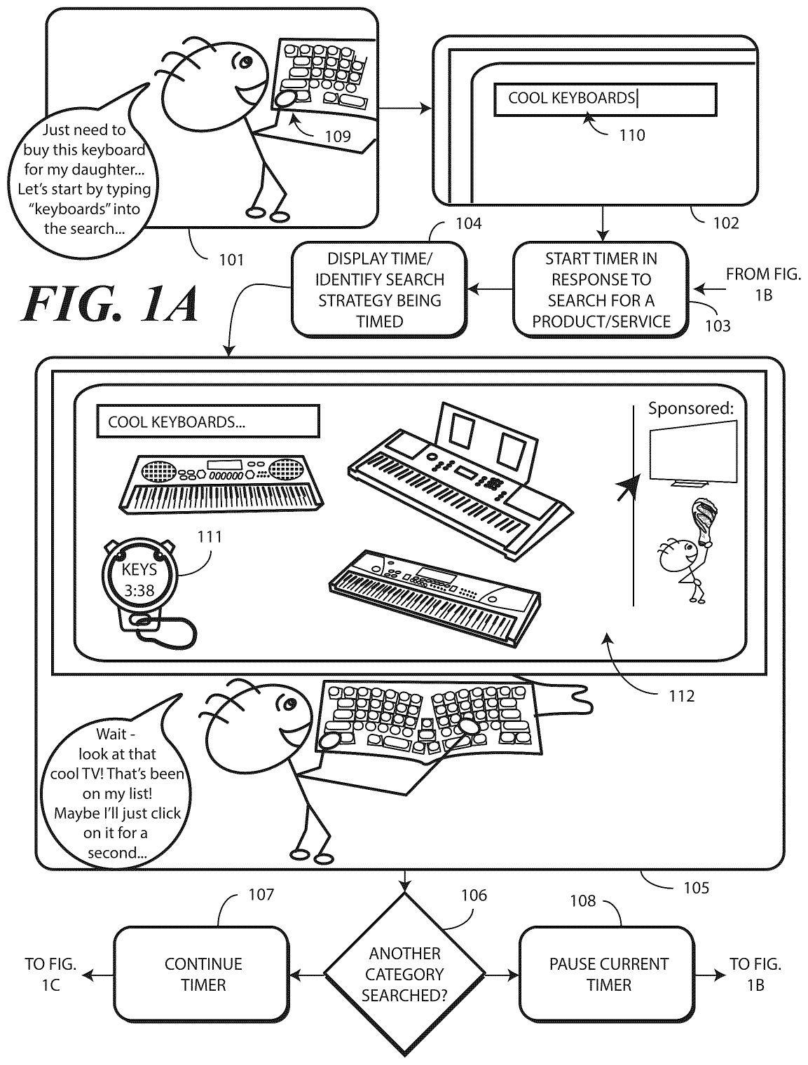

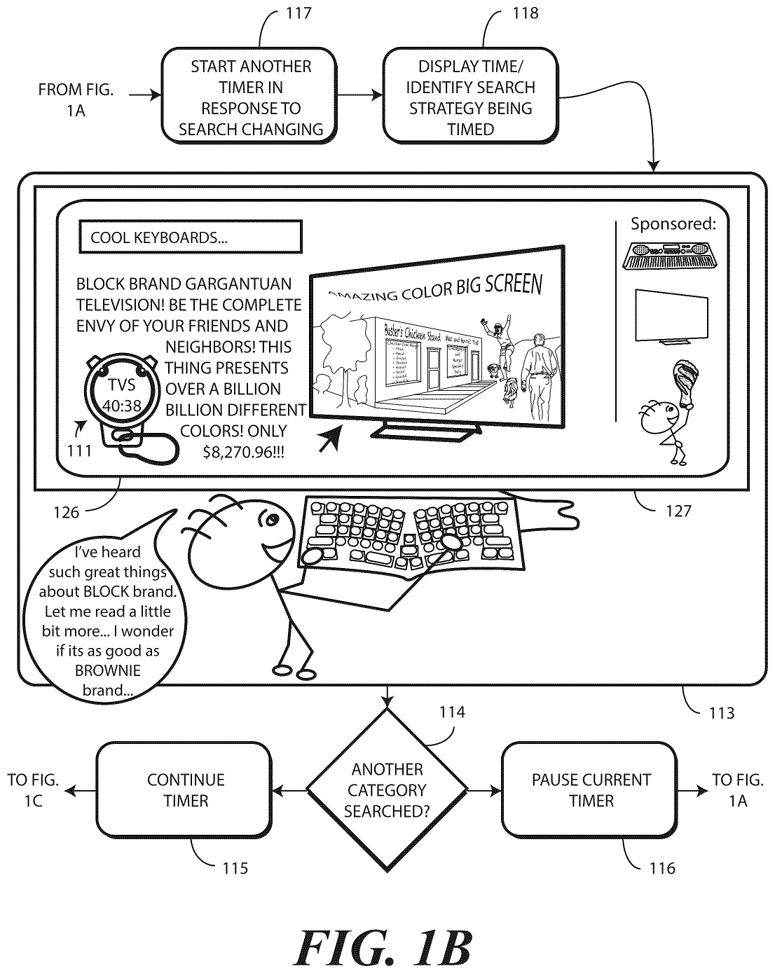

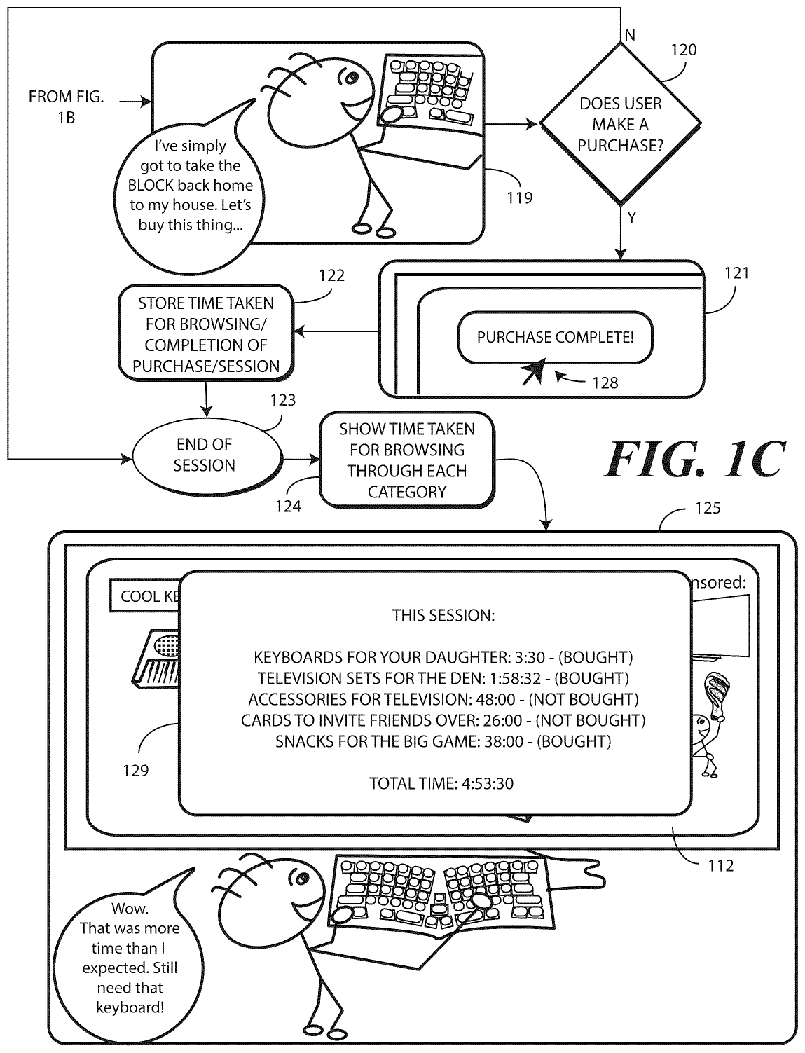

To see how embodiments of the disclosure can work, turn now to FIGS. 1A-1C. Beginning at step 101, or valiant shopper 800, Krish, is again ready to get that really cool keyboard for his daughter so that she can learn to play cool jazz lines like Barry Harris using his infamous minor-sixth-diminished scale with its eight notes over dominant chords by basing that minor-sixth-diminished scale on the five of the chord to wow and amaze her friends. To do so, at step 102 he initiates an interactive session of an electronic shopping interactive computing environment operating on one or more processors of an electronic device by delivering user input 109 defining a search string 110 having a category associated therewith. In this illustrative example, the category associated with the search string 110 is keyboards. At step 102, the one or more processors of the electronic device detect this user input 109.

At step 103, the one or more processors of the electronic device initiate a timer. Additionally, at step 103 the one or more processors monitor user interaction events in the electronic shopping interactive computing environment to determine whether the category associated with the search string 110 changes. If, for example, Krish had typed in really cool televisions, this would constitute a change in category. However, for the moment Krish remains on task and desires to buy that keyboard.

At step 104, the one or more processors of the electronic device present timer data, which can be singular timer data for the time spent in the interactive session while the category is constant, multiple timer data for multiple categories, compilation timer data across a variety of categories, or other timer data. As shown at step 105, in one or more embodiments step 104 comprises presenting the timer data in a stopwatch graphical presentation 111 within the electronic shopping interactive computing environment 112. As shown at step 105, Krish has spent three minutes and thirty-eight seconds shopping for keyboards.

Unfortunately, poor Krish once again gets distracted by the siren song of the really fancy television set. While his poor daughter pines for a keyboard, he once again clicks on the recommendation in the side bar.

In one or more embodiments, decision 106 detects this. Said differently, in one or more embodiments decision 106 comprises monitoring, by the one or more processors of the electronic device, user interaction events (one example of which is Krish's click on the television) in the electronic shopping interactive computing environment to determine whether the category associated with the search string 110 changes. Since the current category is keyboards, the user interaction event of clicking on the television would constitute a change in category detected by decision 106.

In one or more embodiments, when the category associated with the search string 110 fails to change, as determined by decision 106, the timer continues at step 107 until the interactive session ceases. Thereafter, the timer will be stopped.

However, when the category associated with the search string changes to another category associated with another search string, step 108 pauses the timer and initiates another timer. Thus, when Krish clicks on the television, the timer presenting the timer data in the stopwatch graphical presentation 111 of the electronic shopping interactive computing environment 112 will be paused while another timer is started. Since Krish is once again tempted by the allure of wide screens, when he clicks on the television presented in the advertising side bar, this is what happens, which takes us to FIG. 1B.

Turning now to FIG. 1B, at step 117 another timer is initiated. At step 118, user interaction events in the electronic shopping interactive computing environment 112 are monitored to determine whether the category associated with the search string changes again.

As shown at step 113, Krish has really gone down the proverbial rabbit hole. He's spent over forty minutes, as shown in the stopwatch graphical presentation 111 of the electronic shopping interactive computing environment 112 that presents timer data from the new timer and has landed on the best of the best when it comes to televisions, namely, Block Brand gargantuan televisions. They have amazing color, incredibly large screens, and present over a billion billion different colors. If Krish had this Block Brand television, he would certainly be the envy of his neighbors. His mind starts racing about the parties he'd host, sporting events he'd watch, money he'd save by not going to the movies, furniture he'd need for all of his friends, and other related matters. Time certainly flies.

Decision 114 performs a function like decision (106), in that it monitors user interaction events within the electronic shopping interactive computing environment to determine whether the category changes again. If, for example, Krish were to click on the advertisement for Buster's Chicken Stand, this would constitute a change in category since chicken and televisions are clearly in different categories. In one or more embodiments, decision 114 detects this.

Accordingly. in one or more embodiments decision 114 comprises monitoring, by the one or more processors of the electronic device, user interaction events in the electronic shopping interactive computing environment 112 to determine whether the category associated with the search string changes. Since the current category is televisions, the user interaction event of clicking on the Buster's lovely chicken would constitute a change in category detected by decision 114.

In one or more embodiments, when the category associated with the search string fails to change, as determined by decision 114, the timer continues at step 115 until the interactive session ceases. Thereafter, the timer will be stopped. However, when the category associated with the search string changes to another category associated with another search string, step 116 pauses the timer and initiates another timer, as described above.

To illustrate, consider an example. In one or more embodiments, decision 114 monitors, using one or more processors, other user interaction events in the electronic shopping interactive computing environment 112 to determine whether the other category returns to the category associated with the search string. Thus, if Krish were to return to the keyboard search string (110), step 116 would pause the timer associated with the television search string and (returning to step 103 of FIG. 1A) would again start the timer associated with the keyboards. By contrast, when the television category fails to change to another category, be it keyboards, Buster's chicken, or another category, step 115 would continue the other timer until the interactive session ceases and, thereafter, stopping this timer. Once again, step 113 comprises presenting, by the one or more processors on the user interface 126 of the electronic device 127, timer data from the currently running timer associated with the television search string. Once again, the timer data is presented in a stopwatch graphical presentation 111.

Turning now to FIG. 1C, at step 119 Krish decides he simply must own a Block Brand television. Decision 120 detects, by the one or more processors of the electronic device from other user input received by the user interface, whether there is a completion of a shopping cart interaction event corresponding to any of the categories of the search strings searched to date. As shown at step 121, one such shopping cart interaction event 128 occurs when Krish clicks on a “purchase complete” user actuation target. In one or more embodiments, this causes an electronic shopping cart within the electronic shopping interactive computing environment 112 to complete the purchase.

In this illustrative example, Krish has explored both keyboards and televisions. While not shown in the figures, Krish has also searches three additional categories, namely, accessories for televisions (after all, his new Block Brand will require some accoutrements), cards to invite friends over (Krish will want everyone to see his new Block Brand television), and snacks for the big game that Krish plans to watch with all his friends. Accordingly, five different timers were started-a first monitoring the time he spent shopping for keyboards, a second monitoring the time he spent shopping for televisions, a third monitoring his exploration of accessories, a fourth monitoring his time investigating cards, and a fifth monitoring his time searching for snacks. Had Krish clicked on the advertisement for Buster's delicious chicken, a sixth timer would have started and so forth, with a separate timer being initiated for each category and/or search string, and with only one timer running at a time, with that timer monitoring a single category. This information could be stored at step 122. Since Krish's purchase is complete, his interactive shopping session ends at step 123.

At step 124, the one or more processors of the electronic device present a compilation 129 of timer data for the completion of the shopping cart interaction event. Here, the compilation 129 of timer data presents first timer data associated with a first category and search string, second timer data associated with a second category and search string, third timer data associated with a third category and search string, fourth timer data associated with a fourth category and search string, and fifth timer data associated with a fifth category and search string. Additionally, a total amount of time spent on the interactive shopping session within the electronic shopping interactive computing environment 112 is presented as well in this explanatory embodiment.

In this illustrative embodiment, the presentation of the compilation 129 comprises presenting these data in a graphical element, shown here as a banner superimposed atop other images of the electronic shopping interactive computing environment 112 and within the electronic shopping interactive computing environment 112. Thus, as shown in FIG. 1C, step 125 comprises presenting, by the one or more processors on the user interface, the compilation 129 of timer data for the interactive session after the interactive session ceases.

Thus, in one or more embodiments of the disclosure monitor a user's user interaction events within an electronic shopping interactive computing environment for each category of search string, regardless of whether that search string commences with entering search criteria into a search bar, clicking on an advertised product, clicking on a review, or by other user interaction events. While the person is engaged in that category, timer data, sometimes in the form of a stopwatch graphical element, is presented to the user so that they are cognizantly aware of the amount of time spent investigating and exploring that category. Each time the category chances, a new timer is initiated, while a previous timer is paused. However, if the person returns to a previously explored category associated with a previous search string, the previous timer can be resumed. This process can continue until the interactive shopping session ends, which often occurs when there is a completion of an interactive shopping cart event within the electronic shopping interactive computing environment. At this point, embodiments of the disclosure can present a compilation of timer data for the interactive session.

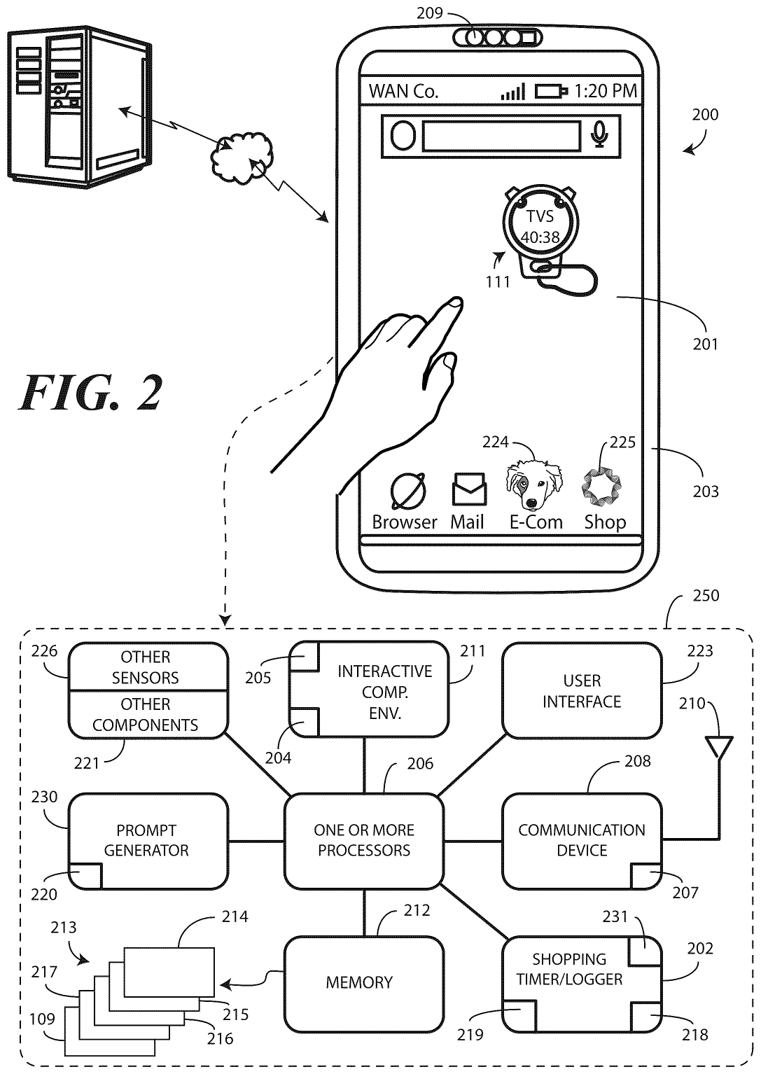

Turning now to FIG. 2, illustrated therein is one electronic device 200 configured in accordance with one or more embodiments of the disclosure. The electronic device 200 of this illustrative embodiment includes a user interface 223. In one or more embodiments, the user interface 223 comprises a display 201, which may optionally be touch-sensitive. The display 201 can serve as a primary user interface 223 of the electronic device 200.

Where the display 201 is touch sensitive, users can deliver user input to the display 201 by delivering touch input from a finger, stylus, or other objects disposed proximately with the display. In one embodiment, the display 201 is configured as an active-matrix organic light emitting diode (AMOLED) display. However, it should be noted that other types of displays, including liquid crystal displays, would be obvious to those of ordinary skill in the art having the benefit of this disclosure.

The explanatory electronic device 200 of FIG. 2 includes a housing 203. Features can be incorporated into the housing 203. Examples of features that can be included along the housing 203 include an imager 209, shown as a camera in FIG. 2, or an optional speaker port. A user interface component, which may be a button or touch sensitive surface, can also be disposed along the housing 203.

A block diagram schematic 250 of the electronic device 200 is also shown in FIG. 2. In one embodiment, the electronic device 200 includes one or more processors 206. In one embodiment, the one or more processors 206 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more Application Specific Integrated Circuits (ASICs), programmable logic, or other type of processing device.

The application processor and the auxiliary processor(s) can be operable with the various components of the electronic device 200. Each of the application processor and the auxiliary processor(s) can be configured to process and execute executable software code to perform the various functions of the electronic device 200. A storage device, such as memory 212, can optionally store the executable software code used by the one or more processors 206 during operation.

In this illustrative embodiment, the electronic device 200 also includes a communication device 208 that can be configured for wired or wireless communication with one or more other devices or networks. The networks can include a wide area network, a local area network, and/or personal area network. The communication device 208 may also utilize wireless technology for communication, such as, but are not limited to, peer-to-peer, or ad hoc communications such as HomeRF, Bluetooth and IEEE 802.11 based communication, or alternatively via other forms of wireless communication such as infrared technology. The communication device 208 can include wireless communication circuitry, one of a receiver, a transmitter, or transceiver, and one or more antennas 210.

The electronic device 200 can optionally include a near field communication circuit 207 used to exchange data, power, and electrical signals between the electronic device 200 and another electronic device. In one embodiment, the near field communication circuit 207 is operable with a wireless near field communication transceiver, which is a form of radio-frequency device configured to send and receive radio-frequency data to and from the companion electronic device or other near field communication objects.

Where included, the near field communication circuit 207 can have its own near field communication circuit controller in one or more embodiments to wirelessly communicate with companion electronic devices using various near field communication technologies and protocols. The near field communication circuit 207 can include—as an antenna—a communication coil that is configured for near-field communication at a particular communication frequency. The term “near-field” as used herein refers generally to a distance of less than about a meter or so. The communication coil communicates by way of a magnetic field emanating from the communication coil when a current is applied to the coil. A communication oscillator applies a current waveform to the coil. The near field communication circuit controller may further modulate the resulting current to transmit and receive data, power, or other communication signals with companion electronic devices.

In one embodiment, the one or more processors 206 can be responsible for performing the primary functions of the electronic device 200. For example, in one embodiment the one or more processors 206 comprise one or more circuits operable to present presentation information, such as images, text, and video, on the display 201. When a shopping application 225 is actuated, the one or more processors 206 can present an electronic shopping interactive computing environment to a user on the display 201, within which the user can make user interaction events. The executable software code used by the one or more processors 206 can be configured as one or more modules 213 that are operable with the one or more processors 206. Such modules 213 can store instructions, control algorithms, and so forth.

In one embodiment, the one or more processors 206 are responsible for running the operating system environment 214. The operating system environment 214 can include a kernel, one or more drivers, and an application service layer 215, and an application layer 216. The operating system environment 214 can be configured as executable code operating on one or more processors or control circuits of the electronic device 200.

The application service layer 215 can be responsible for executing application service modules. The application service modules may support one or more applications 217 or “apps.” Examples of such applications include a cellular telephone application for making voice telephone calls, a web browsing application configured to allow the user to view webpages on the display 201 of the electronic device 200, an electronic mail application configured to send and receive electronic mail, a photo application configured to organize, manage, and present photographs on the display 201 of the electronic device 200, and a camera application for capturing images with the imager 209. Collectively, these applications constitute an “application suite.” In one or more embodiments, these applications comprise one or more e-commerce applications 224 and/or shopping applications 225 that allow electronic commerce orders to be placed and financial transactions to be made using the electronic device 200.

Illustrating by example, in one or more embodiments a user can deliver user input to an e-commerce application 224 to launch an interactive session 204 of an electronic shopping interactive computing environment 211 that operates on the one or more processors 206. They can then deliver user input to the user interface 223 to define one or more search strings corresponding to one or more categories within the electronic shopping interactive computing environment 211. The one or more processors 206 can then monitor user interaction events in the electronic shopping interactive computing environment 211 to determine whether the category associated with the search string changes, as previously described.

The one or more processors 206 can use a shopping timer/logger 202 to initiate a timer 218 in response to user input defining the search string having the category associated therewith in the interactive session 204 of the electronic shopping interactive computing environment 205. When the category associated with the search string changes to another category associated with another search string, the one or more processors 206 can cause the shopping timer/logger 202 to pause the timer 218 and start another timer 219. This process can continue for each category and/or search string. Thus, while two timers 218,219 are shown in FIG. 2, in practice the shopping timer/logger 202 will include many different timers that can be actuated for many different categories and/or search strings. Of course, when the category associated with the search string fails to change, the one or more processors 206 can cause the shopping timer/logger 202 to continue until the interactive session 204 ceases. Thereafter, the one or more processors 206 can cause the shopping timer/logger 202 to stop which ever timer is running.

In one or more embodiments, the timer data is stored by the shopping timer/logger 202 in a timer log as a compilation 231, both separately and summed. In one or more embodiments, when the interactive session 204 of the electronic shopping interactive computing environment 205 ceases, the one or more processors 206 can cause the user interface 223 to present the compilation 231 of timer data for the interactive session 204 after the interactive session 204 ceases, as illustrated above with reference to FIG. 1C.

In one or more embodiments, in response to the one or more processors 206 detecting commencement of the interactive session 204, which in the electronic shopping application 225 is an interactive shopping session, the one or more processors 206 cause the shopping timer/logger 202 to initiate a timer 218,219 for each search string category detected. In response to the interactive shopping session ceasing, the one or more processors 206 cause the shopping timer/logger 202 to present the compilation 231 of timer data for the interactive shopping session on the user interface 223. In one or more embodiments, the compilation 231 of timer data itemizes each search string category and a corresponding amount of time associated with each search string category.

While the interactive shopping session is occurring, the one or more processors 206 can cause the user interface 223 to present output from the timers 218,219 so that a user knows how much time has been spent on the present category. In one or more embodiments, a virtual stopwatch presentation 111 presents a first output from a first timer 218 when the one or more processors 206 detect a first search string category occurring in the electronic shopping application 225, and a second output from a second timer 219 when the one or more processors 206 detect a second search string category occurring in the electronic shopping application 225.

As noted above, when an electronic shopping cart interaction event associated with a detected search string category completes, the one or more processors 206 can cause the shopping timer/logger 202 to present the compilation 231. In one or more embodiments, the compilation presents an elapsed time associated with each detected search string category. Since a user may not buy every single thing they look at, in one or more embodiments the compilation 231 comprises at least some timer data corresponding to at least some search string categories failing to result in completed electronic shopping cart interaction events.

In one or more embodiments, the compilation 231 of timer data is presented when someone adds an item to an electronic shopping cart, which is known as an electronic shopping cart interaction event and completes a purchase of the items in the electronic shopping cart. Accordingly, in one or more embodiments the one or more processors 206 detect, from user input received at the user interface 223, completion of an electronic shopping cart interaction event corresponding to a category associated with a search string or another category associated with another search string in an electronic shopping cart of the electronic shopping interactive computing environment 205. When this occurs, in one or more embodiments the one or more processors 206 cause the shopping timer/logger 202 to stop any running timers 218,219. The one or more processors 206 can then cause the shopping timer/logger 202 to present the data from the timers 218,219 and a compilation 231 of the timer data for the interactive session 204, with that compilation including the data from the timers 218,219.

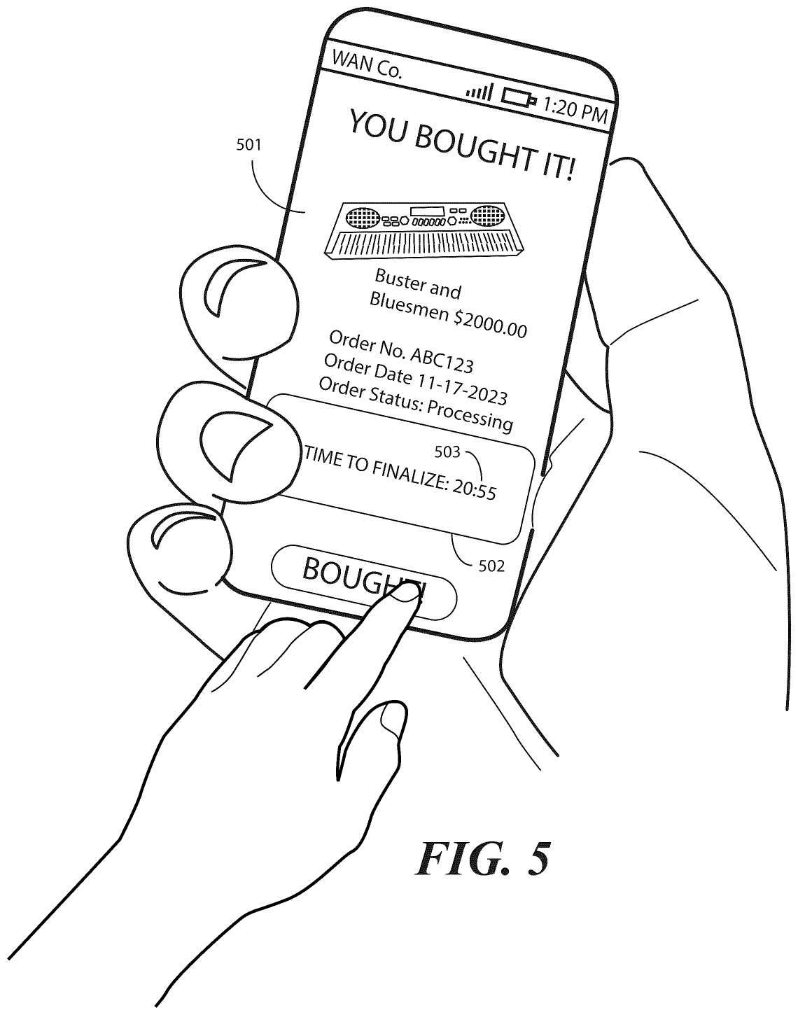

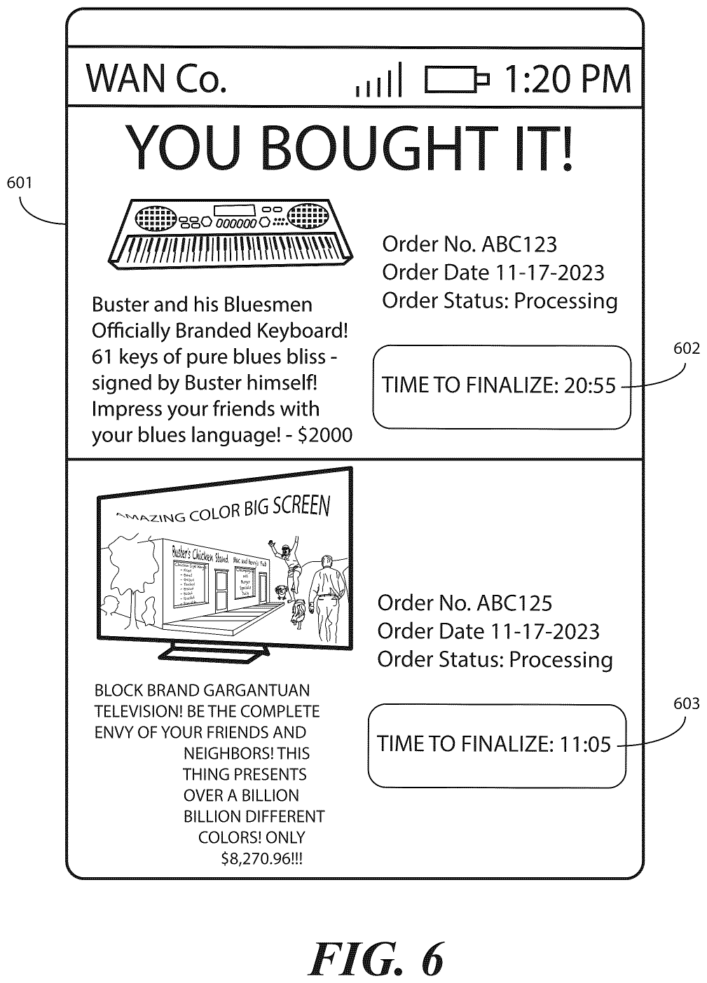

Since many search strings can be searched during an interactive session 204, the compilation 231 can further comprise additional data from an additional timer initiated for an additional category associated with an additional search string that failed to result in completion of any electronic shopping cart interaction events in the electronic shopping interactive computing environment 205. As was the case in FIG. 1C above, the compilation 231 of the timer data can be presented in a prompt atop the electronic shopping interactive computing environment. However, in other embodiments, examples of which will be shown below in FIGS. 5 and 6, the compilation 231 of timer data can be presented in a non-superimposed format within the electronic shopping interactive computing environment 205. Other presentations will be obvious to those of ordinary skill in the art having the benefit of this disclosure.

In one or more embodiments, the one or more processors 206 are responsible for managing the applications and all personal information received from the user interface 223 that is to be used by the e-commerce application 224 and/or electronic shopping application 225 after the electronic device 200 is authenticated as a secure electronic device and the user identification credentials have triggered an electronic payment transaction request to complete an electronic shopping cart interaction event. The one or more processors 206 can also be responsible for launching, monitoring, and killing the various applications and the various application service modules. In one or more embodiments, the one or more processors 206 are operable to not only kill the applications, but also to expunge any and all personal data, data, files, settings, or other configuration tools when the electronic device 200 is reported stolen or when the e-commerce application 224 and/or electronic shopping application 225 are used with fraudulent activity to wipe the memory 212 clean of any personal data, preferences, or settings of the person previously using the electronic device 200.

The one or more processors 206 can also be operable with other components 221. The other components 221, in one embodiment, include input components, which can include acoustic detectors as one or more microphones. The one or more processors 206 may process information from the other components 221 alone or in combination with other data, such as the information stored in the memory 212 or information received from the user interface.

The other components 221 can include a video input component such as an optical sensor, another audio input component such as a second microphone, and a mechanical input component such as button. The other components 221 can include one or more sensors 226, which may include key selection sensors, touch pad sensors, capacitive sensors, motion sensors, and switches. Similarly, the other components 221 can include video, audio, and/or mechanical outputs.

The one or more sensors 226 may include, but are not limited to, accelerometers, touch sensors, surface/housing capacitive sensors, audio sensors, and video sensors. Touch sensors may be used to indicate whether the electronic device 200 is being touched at side edges. The other components 221 of the electronic device can also include a device interface to provide a direct connection to auxiliary components or accessories for additional or enhanced functionality and a power source, such as a portable battery, for providing power to the other internal components and allow portability of the electronic device 200.

In one or more embodiments, the electronic device 200 comprises a prompt generator 230 as well. In one or more embodiments, the prompt generator generates a prompt 220 comprising either currently active timer data while an interactive session 204 of an electronic shopping interactive computing environment 205 is occurring, one example of which is the stopwatch graphical representation 111, or compilation 231 timer data when an interactive session 204 of an electronic shopping interactive computing environment 205 is completed. Illustrating by example, the one or more processors 206 can present, on the user interface 223, a prompt 220 generated by the prompt generator 230 comprising the compilation 231 of timer data after an electronic shopping cart interaction event completes.

In one or more embodiments, the shopping timer/logger 202 and the prompt generator 230 can be operable with one or more processors 206, configured as a component of the one or more processors 206, or configured as one or more executable code modules operating on the one or more processors 206. In other embodiments, the shopping timer/logger 202 and the prompt generator 230 can be standalone hardware components operating executable code or firmware to perform their functions. Other configurations for the shopping timer/logger 202 and the prompt generator 230 will be obvious to those of ordinary skill in the art having the benefit of this disclosure.

It is to be understood that FIG. 2 is provided for illustrative purposes only and for illustrating components of one electronic device 200 in accordance with embodiments of the disclosure and is not intended to be a complete schematic diagram of the various components required for an electronic device. Therefore, other electronic devices in accordance with embodiments of the disclosure may include various other components not shown in FIG. 2 or may include a combination of two or more components or a division of a particular component into two or more separate components, and still be within the scope of the present disclosure.

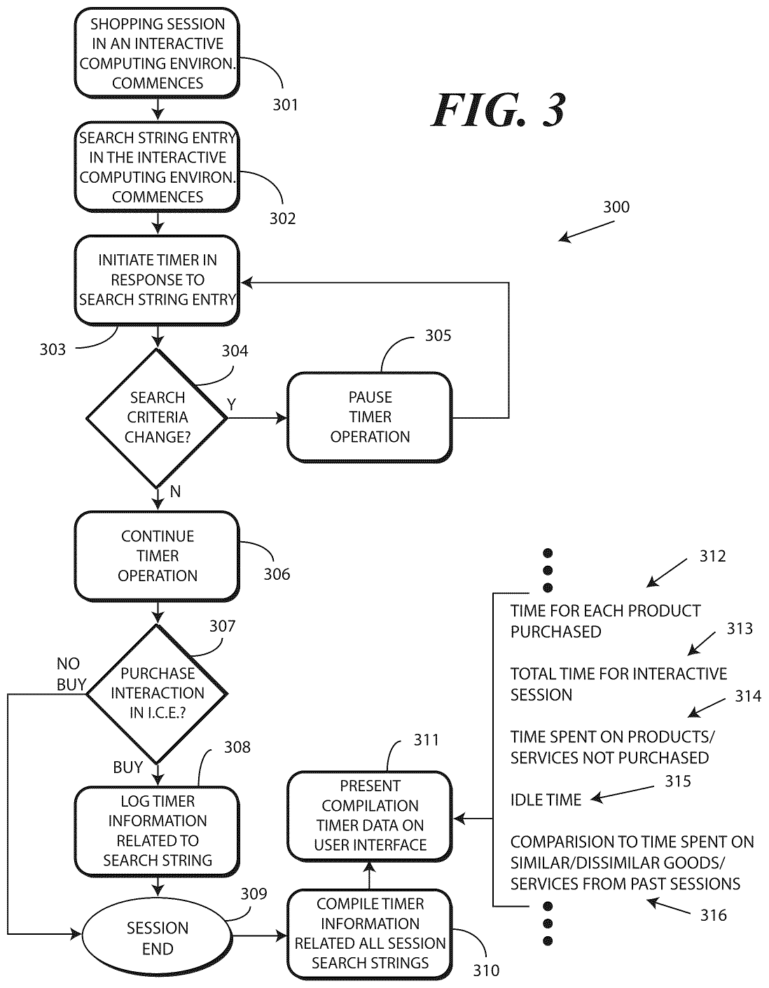

Turning now to FIG. 3, illustrated therein is one explanatory method 300 in accordance with one or more embodiments of the disclosure. Beginning at step 301, a user delivers user input to a user interface of an electronic device to initiate an electronic shopping interactive computing environment operating on one or more processors of the electronic device. At step 302, other user input defining a search string having a category associated therewith is delivered to the user interface of the electronic device.

This user input defining the search string can take a variety of forms. In one or more embodiments, the user simply inters search string terms into a search portal of the electronic shopping interactive computing environment. In other embodiments, however, the user defines the search string differently. For instance, the user may simply click on a link corresponding to a particular product, which constitutes the entry of a search string with a category associated therewith corresponding to the product. In still other embodiments, the user may click on a link corresponding to a review of a product to generate the effective search string having the category associated therewith. The user may click on links to other “related” products that the user may be interested, for example, such as clicking on a link for cheese when purchasing wine. This diversion from wine to cheese would constitute another search string having another category associated therewith. Other techniques for defining a search string having a category associated therewith will be obvious to those of ordinary skill in the art having the benefit of this disclosure.

At step 303, one or more processors of the electronic device initiate a timer. Decision 304 monitors, using the one or more processors, user interaction events in the electronic shopping interactive computing environment to determine whether the category associated with the search string changes. When the category associated with the search string changes to another category associated with another search string, step 305 pauses the timer and returns to step 303, which then initiates another timer for the newly detected category. However, when the category associated with the search string fails to change, step 306 continues the timer started at step 303 until the interactive session ceases. Thus, steps 303,305, when combined with decision 304, initiate a timer for each detected category of activity occurring during in interactive session of an electronic shopping interactive computing environment operating on the one or more processors of the electronic device. Decision 307 detects completion of an interactive session within an electronic shopping interactive computing environment. In one or more embodiments, decision 307 detects this completion by detecting completion of an interactive shopping cart event within the electronic shopping interactive computing environment for at least one detected category of activity. However, embodiments of the disclosure contemplate that in many scenarios a user will not buy an item and will instead just end the interactive session at step 309.

Where an electronic shopping cart interaction event completes, step 308 comprises stopping, by the one or more processors, any running timer. The interactive session then ends at step 309. Step 310 then compiles all timer information associated with all categories and search strings during the interactive session. Step 311 then presents, by the one or more processors on a user interface, a compilation of data from the timers for each detected category of activity occurring during the interactive session.

As shown in FIG. 3, this compilation of data can take a variety of forms. In one or more embodiments, the compilation presents an amount of time 312 spent for each product purchased with the completion of the electronic shopping cart interaction event. In one or more embodiments, the compilation also presents the total amount of time 313 for the interactive session.

In one or more embodiments, the compilation also presents the amount of time 314 spent on products or services that were not purchased. It should be clear by now that this information would have been very helpful for Krish when shopping for keyboards! In one or more embodiments, the compilation also presents an amount of idle time 315 when no activity or user interaction events were occurring in the electronic shopping interactive computing environment.

Other interesting data can be presented as well. Illustrating by example, in one or more embodiments the compilation presents a comparison 316 of amounts of time spent on similar or dissimilar goods and services from past sessions. If Krish's search for the keyboard occurring in FIGS. 1A-1C above was his third such venture into the electronic shopping interactive computing environment world of keyboards, this comparison 316 may show Krish how much time he tends to spend shopping for himself rather than for his daughter. This information may encourage Krish to really buckle down next time and buy that Buster's Bluesmen or Mack and Henry Fugue model next time. Other information that can be shown in the compilation at step 311 will be obvious to those of ordinary skill in the art having the benefit of this disclosure.

As described above, embodiments of the disclosure monitor a user's user interaction events within an electronic shopping interactive computing environment for each category of search string, regardless of whether that search string commences with entering search criteria into a search bar, clicking on an advertised product, clicking on a review, or by other user interaction events. While the person is engaged in that category, timer data, sometimes in the form of a stopwatch graphical element, is presented to the user so that they are cognizantly aware of the amount of time spent investigating and exploring that category. Each time the category chances, a new timer is initiated, while a previous timer is paused. However, if the person returns to a previously explored category associated with a previous search string, the previous timer can be resumed. This process can continue until the interactive shopping session ends, which often occurs when there is a completion of an interactive shopping cart event within the electronic shopping interactive computing environment. At this point, embodiments of the disclosure can present a compilation of timer data for the interactive session.

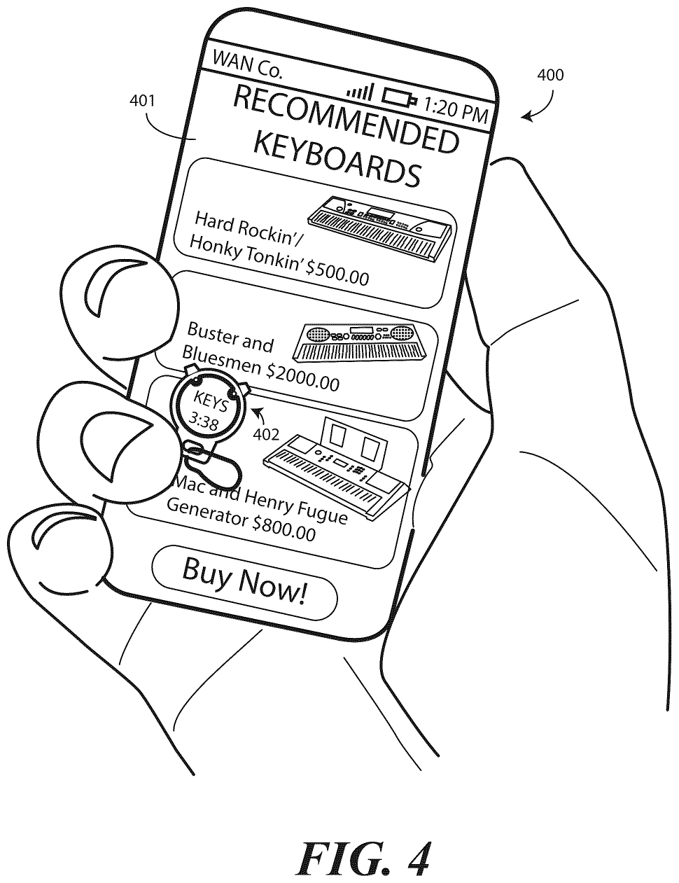

Turning now to FIGS. 4-6, illustrated therein are a few user interfaces 401,501,601 illustrating how embodiments of the disclosure may be implemented. These user interfaces 401,501,601 are illustrative only and are intended to demonstrate how timer data may be presented within an electronic shopping interactive computing environment in accordance with one or more embodiments of the disclosure. Others will be obvious to those of ordinary skill in the art having the benefit of this disclosure.

Beginning with FIG. 4, here a user has delivered user input to a user interface 401 to define a search string having a category associated therewith by clicking on a link that said, “recommended keyboards,” and that was based upon a search history stored within the electronic device 400 from previous forays into the electronic shopping interactive computing environment. In this illustrative embodiment, one or more processors of the electronic device 400 present, on the user interface 401, output 402 from a timer while the interactive session is in progress. In this example, the output 402 from the timer comprises a single output from a single timer corresponding to a contemporaneously detected category activity, which is searching for keyboards.

In FIG. 5, the user is delivering user input to the user interface 501 completing an electronic shopping cart interaction event to purchase the Buster and Bluesman keyboard. Here, the compilation 502 presented comprises at least one timer output 503 associated with at least one detected category of activity. The user interface 601 of FIG. 6 differs, in that it shows multiple timer outputs 602,603, with one timer output being associated with each product purchased with an electronic shopping cart interaction event.

In some embodiments, the compilation presented at the end will also depict the amount of time spent on products or services that were not purchased. Accordingly, in one or more embodiments the compilation will comprise at least one timer output associated with at least one detected category of activity that fails to result in a completed electronic shopping cart event within the electronic shopping interactive computing environment as well.

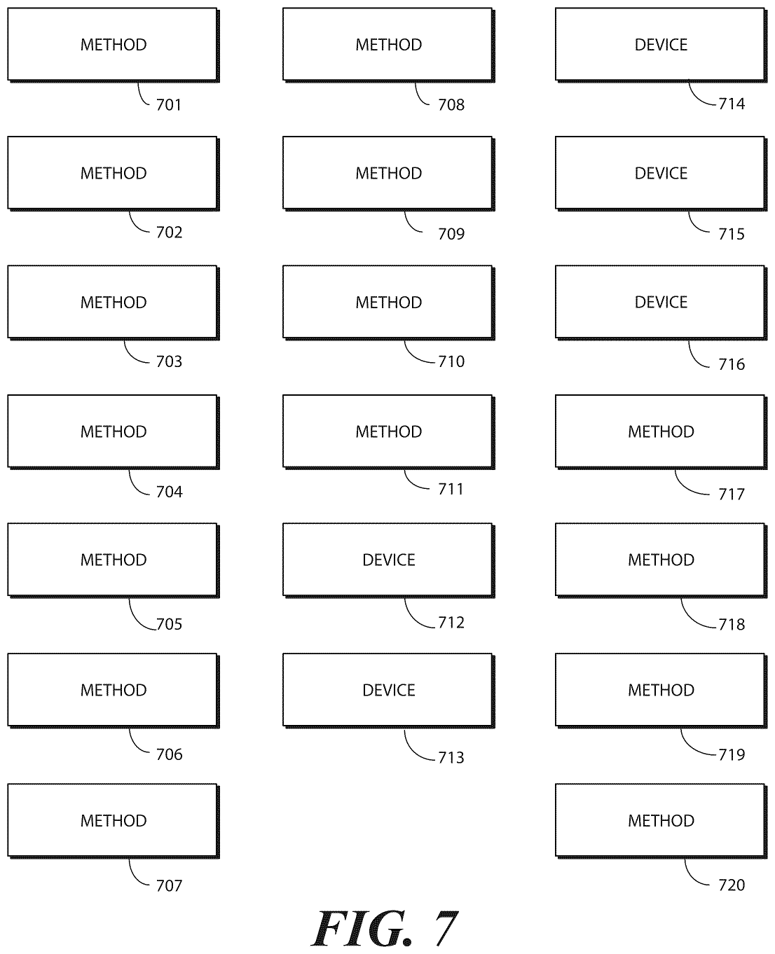

Turning now to FIG. 7, illustrated therein are various embodiments of the disclosure. The embodiments of FIG. 7 are shown as labeled boxes in FIG. 7 due to the fact that the individual components of these embodiments have been illustrated in detail in FIGS. 1-6, which precede FIG. 7. Accordingly, since these items have previously been illustrated and described, their repeated illustration is no longer essential for a proper understanding of these embodiments. Thus, the embodiments are shown as labeled boxes.

At 701, a method in an electronic device comprises, in response to initiation of an interactive session in an electronic shopping interactive computing environment operating on one or more processors of the electronic device, detecting, by a user interface operable with the one or more processors, user input defining a search string having a category associated therewith. At 701, the method comprises initiating, by the one or more processors in response to the user input, a timer.

At 701, the method comprises monitoring, by the one or more processors, user interaction events in the electronic shopping interactive computing environment to determine whether the category associated with the search string changes. At 701, when the category associated with the search string fails to change, the method comprises continuing the timer until the interactive session ceases and, thereafter, stopping the timer. At 701, when the category associated with the search string changes to another category associated with another search string, the method comprises pausing the timer and initiating another timer.

At 702, the method of 701 further comprises presenting, by the one or more processors on the user interface, a compilation of timer data for the interactive session after the interactive session ceases.

At 703, the method of 701 further comprises monitoring, by the one or more processors, other user interaction events in the electronic shopping interactive computing environment to determine whether the other category returns to the category associated with the search string. At 703, when the other category associated with the other search string fails to change, the method comprises continuing the other timer until the interactive session ceases and, thereafter, stopping the other timer. At 703, when the other category associated with the other search string returns to the category associated with the search string, the method comprises pausing the other timer and resuming the timer.

At 704, the method of 703 further comprises presenting, by the one or more processors on the user interface, a compilation of timer data for the interactive session after the interactive session ceases. At 705, the method of 703 further comprises detecting, by the user interface operable with the one or more processors, additional user input defining an additional search string having an additional category associated therewith and, in response to the user input, pausing, by the one or more processors the timer and the other timer and starting an additional timer.

At 706, the method of 701 further comprises detecting, by the one or more processors from other user input received by the user interface, completion of a shopping cart interaction event corresponding to one or both of the category associated with the search string, or the other category associated with the other search string in an electronic shopping cart within the electronic shopping interactive computing environment. At 706, the method comprises stopping one or both of the timer and/or the other timer and presenting, by the one or more processors on the user interface, a compilation of timer data for the completion of the shopping cart interaction event.

At 707, the method of 701 further comprises presenting, by the one or more processors on the user interface, one or more of timer data from the timer and/or other timer data from the other timer. At 708, the presenting of 707 comprises presenting the one or more of the timer data from the timer and/or the other timer data from the other timer in a graphical element within the electronic shopping interactive computing environment.

At 709, the method of 701 further comprises detecting, by the one or more processors from other user input received by the user interface, completion of a shopping cart interaction event corresponding to the category associated with the search string or the other category associated with another search string in an electronic shopping cart within the electronic shopping interactive computing environment. At 709, the method comprises stopping the timer.

At 709, the method comprises also detecting, by the one or more processors from the other user input received by the user interface, completion of another shopping cart interaction event corresponding to the other category associated with the other search string in the electronic shopping cart within the electronic shopping interactive computing environment. At 709, the method comprises stopping the other timer.

At 709, the method comprises presenting, by the one or more processors on the user interface, data from the timer, other data from the other timer, and a compilation of timer data for the interactive session, wherein the compilation includes at least the data and the other data. At 710, the compilation of 709 further comprises additional data from an additional timer initiated for an additional category associated with an additional search string that failed to result in completion of any electronic shopping cart interaction events in the electronic shopping interactive computing environment.

At 711, the compilation of the timer data of 710 is presented in a prompt atop the electronic shopping interactive computing environment or in a non-superimposed format in the electronic shopping interactive computing environment.

At 712, an electronic device comprises a user interface, a memory, and one or more processors operable with the user interface and the memory. At 712, in response to the one or more processors detecting commencement of an interactive shopping session in an electronic shopping application operating on the one or more processors, the one or more processors initiate a timer for each search string category detected. At 712, in response to the interactive shopping session ceasing, the one or more processors present a compilation of timer data for the interactive shopping session itemizing each search string category and a corresponding amount of time associated with each search string category.

At 713, the one or more processors of 712 are further configured to present output from the timer on the user interface. At 714, a virtual stopwatch of 713 presents a first output from a first timer when the one or more processors detect a first search string category occurring in the electronic shopping application and a second output from a second timer when the one or more processors detect a second search string category occurring in the electronic shopping application.

At 715, the one or more processors of 714 are further configured to, in response to detecting completion of an electronic shopping cart interaction event associated with a detected search sting category, present an elapsed time associated with the detected search string category. At 716, the compilation of timer data of 715 comprises at least some timer data corresponding to at least some search string categories failing to result in completed electronic shopping cart interaction events.

At 717, a method in an electronic device comprises imitating, by one or more processors, a timer for each detected category of activity occurring during an interactive session of an electronic shopping interactive computing environment operating on the one or more processors of the electronic device. At 717, the method comprises detecting, by the one or more processors, completion of an interactive shopping cart event within the electronic shopping interactive computing environment for at least one detected category of the activity.

At 717, the method comprises stopping, by the one or more processors, the timer in response to completion of the interactive shopping cart event within the electronic shopping interactive computing environment. At 717, the method comprises presenting, by the one or more processors on a user interface of the electronic device, a compilation of data from the timer for each detected category of activity occurring during the interactive session.

At 718, the method of 717 further comprises presenting, by the one or more processors on the user interface, output from the timer while the interactive session is in progress. At 719, the output from the timer of 718 comprises a single output from a single timer corresponding to a contemporaneously detected category activity. At 720, the compilation of 719 comprises at least one timer output associated with at least one detected category of activity failing to result in a completed interactive shopping cart event within the electronic shopping interactive computing environment.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method for an electronic device, the method comprising:
in response to initiation of an interactive session in an electronic shopping interactive computing environment operating on one or more processors of the electronic device, detecting, by a user interface operable with the one or more processors, user input defining a search string having a category associated therewith:
initiating, by the one or more processors in response to the user input, a timer:
monitoring, by the one or more processors, user interaction events in the electronic shopping interactive computing environment to determine whether the category associated with the search string changes; and
when the category associated with the search string fails to change, continuing the timer until the interactive session ceases and, thereafter, stopping the timer; and
when the category associated with the search string changes to another category associated with another search string, pausing the timer and initiating another timer.

2. The method of claim 1, further comprising presenting, by the one or more processors on the user interface, a compilation of timer data for the interactive session after the interactive session ceases.

3. The method of claim 1, further comprising:
monitoring, by the one or more processors, other user interaction events in the electronic shopping interactive computing environment to determine whether the another category returns to the category associated with the search string; and
when the another category associated with the another search string fails to change, continuing the another timer until the interactive session ceases and, thereafter, stopping the another timer; and
when the another category associated with the another search string returns to the category associated with the search string, pausing the another timer and resuming the timer.

4. The method of claim 3, further comprising presenting, by the one or more processors on the user interface, a compilation of timer data for the interactive session after the interactive session ceases.

5. The method of claim 3, further comprising:
detecting, by the user interface operable with the one or more processors, additional user input defining an additional search string having an additional category associated therewith; and
in response to the user input, pausing, by the one or more processors the timer and the another timer and starting an additional timer.

6. The method of claim 1, further comprising:
detecting, by the one or more processors from other user input received by the user interface, completion of a shopping cart interaction event corresponding to one or both of the category associated with the search string or the another category associated with the another search string in an electronic shopping cart within the electronic shopping interactive computing environment;
stopping one or both of the timer and/or the another timer; and
presenting, by the one or more processors on the user interface, a compilation of timer data for the completion of the shopping cart interaction event.

7. The method of claim 1, further comprising presenting, by the one or more processors on the user interface, one or more of timer data from the timer and/or other timer data from the another timer.

8. The method of claim 7, wherein the presenting comprises presenting the one or more of the timer data from the timer and/or the other timer data from the another timer in a graphical element within the electronic shopping interactive computing environment.

9. The method of claim 1, further comprising:
detecting, by the one or more processors from other user input received by the user interface, completion of a shopping cart interaction event corresponding to the category associated with the search string or the another category associated with another search string in an electronic shopping cart within the electronic shopping interactive computing environment:
stopping the timer:
also detecting, by the one or more processors from the other user input received by the user interface, completion of another shopping cart interaction event corresponding to the another category associated with the another search string in the electronic shopping cart within the electronic shopping interactive computing environment:
stopping the another timer; and
presenting, by the one or more processors on the user interface:
data from the timer:
other data from the another timer; and
a compilation of timer data for the interactive session, wherein the compilation includes at least the data and the other data.

10. The method of claim 9, wherein the compilation further comprises additional data from an additional timer initiated for an additional category associated with an additional search string that failed to result in completion of any electronic shopping cart interaction events in the electronic shopping interactive computing environment.

11. The method of claim 10, wherein the compilation of the timer data is presented in a prompt atop the electronic shopping interactive computing environment or in a non-superimposed format in the electronic shopping interactive computing environment.

12. An electronic device, comprising:
a user interface:
a memory; and
one or more processors operable with the user interface and the memory:
wherein:
in response to the one or more processors detecting commencement of an interactive shopping session in an electronic shopping application operating on the one or more processors, the one or more processors initiate a timer for each search string category detected; and
in response to the interactive shopping session ceasing, the one or more processors present a compilation of timer data for the interactive shopping session itemizing the each search string category and a corresponding amount of time associated with the each search string category.

13. The electronic device of claim 12, the one or more processors further configured to present output from the timer on the user interface.

14. The electronic device of claim 13, wherein a virtual stopwatch presents a first output from a first timer when the one or more processors detect a first search string category occurring in the electronic shopping application and a second output from a second timer when the one or more processors detect a second search string category occurring in the electronic shopping application.

15. The electronic device of claim 14, wherein the one or more processors are further configured to, in response to detecting completion of an electronic shopping cart interaction event associated with a detected search sting category, present an elapsed time associated with the detected search string category.

16. The electronic device of claim 15, wherein the compilation of timer data comprises at least some timer data corresponding to at least some search string categories failing to result in completed electronic shopping cart interaction events.

17. A method in an electronic device, the method comprising:
imitating, by one or more processors, a timer for each detected category of activity occurring during an interactive session of an electronic shopping interactive computing environment operating on the one or more processors of the electronic device:
detecting, by the one or more processors, completion of an interactive shopping cart event within the electronic shopping interactive computing environment for at least one detected category of the activity:
stopping, by the one or more processors, the timer in response to completion of the interactive shopping cart event within the electronic shopping interactive computing environment; and
presenting, by the one or more processors on a user interface of the electronic device, a compilation of data from the timer for the each detected category of activity occurring during the interactive session.

18. The method of claim 17, further comprising, presenting, by the one or more processors on the user interface, output from the timer while the interactive session is in progress.

19. The method of claim 18, wherein the output from the timer comprises a single output from a single timer corresponding to a contemporaneously detected category activity.

20. The method of claim 19, wherein the compilation comprises at least one timer output associated with at least one detected category of activity failing to result in a completed interactive shopping cart event within the electronic shopping interactive computing environment.
